(19) United States
(12) Patent Application Publication
(10) Pub. No.: US 2021/0045416 A1
(43) Pub. Date: Feb. 18, 2021

(54) METHOD FOR PRODUCING INSTANT NOODLES CONTAINING POTASSIUM LACTATE

(71) Applicant: NISSIN FOODS HOLDINGS CO., LTD., Osaka-shi Osaka (JP)

(72) Inventors: Sho KITANO, Osaka (JP); Atsushi MATSUMURA, Osaka (JP); Hiroyuki KONO, Osaka (JP)

(21) Appl. No.: 16/965,516

(22) PCT Filed: Feb. 14, 2019
(86) PCT No.: PCT/JP2019/005179

§ 371 Date: Jul. 28, 2020

(30) Foreign Application Priority Data
Feb. 21, 2018 (JP) 2018-028851

(51) Int. Cl. A23L 7/113; A23L 27/40; A23L 27/00

(52) U.S. Cl. CPC A23L 7/113; A23L 27/88; A23L 27/45

(57) ABSTRACT

[Problem to be Solved]

Although potassium lactate is expected as a substitute for salt, it was revealed to impair noodle making properties. Therefore, an object of the present invention is to produce instant noodles to which a salty taste owing to potassium lactate is imparted, and which has good texture.

[Solution]

The present inventors found that an adverse effect of potassium lactate caused during noodle making can be suppressed by adding potassium lactate after noodle making of noodle strings. Thus, the present invention was accomplished so that a salty taste owing to potassium lactate can be imparted and texture of noodles can be retained.

### TECHNICAL FIELD

The present invention relates to a method for producing potassium lactate-containing instant noodles having adequate salty taste and texture.

### BACKGROUND ART

In production of noodles in general, salt (sodium chloride) is added in many cases in producing noodle strings from a raw material powder such as wheat flour. Such addition aims to improve noodle making properties and texture by enhancing elasticity and extensibility of resultant noodle strings through an action of sodium chloride on gluten contained in the noodle strings.

In recent years, however, a large number of the so-called low-salt products having a reduced sodium chloride content for preventing high blood pressure otherwise caused through excessive intake of sodium are placed on the market. According to “Dietary Reference Intakes for Japanese” issued by the Ministry of Health, Labour and Welfare, the recommended daily salt intake is less than 9 g for an adult male and less than 7.5 g for an adult female in the 2010 edition, but the recommended daily salt intake is reduced to less than 8 g for an adult male and less than 7 g for an adult female in the 2015 edition. Thus, consciousness of salt reduction will be probably continuously increasing.

In response to the increase of the concern about salt reduction, food in which sodium lactate is added for enhancing a salty taste has been proposed (Patent Literature 4), but such food is inadequate from the viewpoint of reduction of an amount of sodium used.

Furthermore, Patent Literature 5 discloses a method for producing noodles in which lactic acid and lactate in the form of a 1% by mass aqueous solution having pH of 4.0 to 5.5 is used in a step of preparing noodle dough and a step of boiling noodle strings. Since it is not presumed to use kansui together in this method, however, this method is inadequate to solve a problem of the present invention described later.

Accordingly, the present inventors started to develop instant noodles in which potassium lactate is added instead of sodium lactate. In the course of the development, a problem of an adverse effect of potassium lactate on noodle making properties was found, and the present invention was conceived to solve this problem.

### CITATION LIST

### Patent Literature

Patent Literature 1: Japanese Patent Laid-Open No. 2015-84772

Patent Literature 2: Japanese Patent Laid-Open No. 2015-213434

Patent Literature 3: Japanese Patent Laid-Open No. 2016-067293

Patent Literature 4: Japanese Patent Laid-Open No. 9-103236

Patent Literature 5: Japanese Patent Laid-Open No. 2002-27930

### SUMMARY OF INVENTION

### Technical Problem

An object of the present invention is to produce potassium lactate-containing instant noodles having adequate salty taste and texture.

### Solution to Problem

The present inventors have found that an adverse effect of potassium lactate caused during noodle making can be suppressed by adding potassium lactate after the noodle making. Thus, the present invention was accomplished, and as a result, a salty taste owing to potassium lactate can be imparted to noodles and texture of the noodles can be retained.

More specifically, the present invention relates to a method for producing instant noodles, including at least the following steps 1 to 3:

step 1 of kneading a raw material powder, water and kansui to produce noodle dough (kneading step);

step 2 of producing noodle strings from the noodle dough; and

step 3 of adding potassium lactate to the noodle strings (flavoring step).

### Advantageous Effects of Invention

The present invention has been accomplished so that potassium lactate-containing instant noodles having adequate salty taste and texture can be provided.

### BRIEF DESCRIPTION OF DRAWINGS

FIG. 1 is a graph of dough properties of dough 1 (Trial Example 1) measured using a Farinograph.

FIG. 2 is a graph of dough properties of dough 2 (Trial Example 2) measured using a Farinograph.

FIG. 3 is a graph of dough properties of dough 3 (Trial Example 3) measured using a Farinograph.

FIG. 4 is a graph of dough properties of dough 4 (Trial Example 4) measured using a Farinograph.

FIG. 5 is a graph comparing the dough properties between Trial Example 1 and Trial Example 2.

FIG. 6 is a graph comparing the dough properties between Trial Example 3 and Trial Example 2.

FIG. 7 is a graph comparing the dough properties between Trial Example 4 and Trial Example 2.

### DESCRIPTION OF EMBODIMENT

Now, an embodiment of the present invention will be specifically described.

1. Raw Materials

Instant noodles produced by the present invention need to contain potassium lactate, kansui, and a raw material powder. First, these raw materials will be described in detail.

1-1. Potassium Lactate

Potassium lactate is known as a material having not only an effect of increasing a salty taste but also a moisturizing effect and a bacteriostatic effect, and is generally added in an initial step (kneading step) of the production. As a result of examinations made by the present inventors, however, it was revealed that potassium lactate impairs noodle making properties of kansui. Therefore, in the present invention, a step of adding potassium lactate (flavoring step) is provided after noodle making, and thus, a salty taste is enhanced without impairing the noodle making properties.

The present invention does not completely exclude addition of potassium lactate during the noodle making Specifically, when the amount of potassium lactate added during the noodle making is about a half (in a weight ratio) of the amount of kansui added, the noodle making properties are not largely deteriorated. The adverse effect of potassium lactate may become conspicuous depending on the amount of gluten contained in wheat, and a salt (such as sodium chloride or potassium chloride) used together. Accordingly, in the present invention, the amount of potassium lactate added during the noodle making is preferably a half of the amount of kansui added, and it is more preferable that potassium lactate is not substantially added during the noodle making.

The amount of potassium lactate added is, with respect to a total amount of the instant noodles, preferably 0.1 to 2.5% by weight, more preferably 0.2 to 1.5% by weight, and further preferably 0.3 to 1.0% by weight. When the content of potassium lactate is less than 0.1% by weight, the effect of increasing a salty taste is weak. On the other hand, when the content of potassium lactate exceeds 2.5% by weight, an acidic taste of potassium lactate is so strong that the flavor of the noodles is easily deteriorated. In addition, a water absorption property is too strong, and hence the resultant noodles tend to be softened. It is noted that the content of potassium lactate is preferably 0.2 to 1.5% by weight, and more preferably 0.3 to 1.0% by weight with respect to the total amount of the instant noodles.

1-2. Kansui

The term “kansui” herein used refers to an alkali salt used in the production of Chinese noodles or udon, and specific examples include carbonates such as potassium carbonate and sodium carbonate, pyrophosphates such as tetrapotassium pyrophosphate and sodium pyrophosphate, polyphosphates such as potassium polyphosphate and sodium polyphosphate, metaphosphates such as potassium metaphosphate and sodium metaphosphate, and phosphates such as tripotassium phosphate, dipotassium hydrogen phosphate, potassium dihydrogen phosphate and trisodium phosphate.

When kansui is added, the following advantages can be obtained:

(1) Kansui acts on an organic matter to cause an alkaline odor of pyrrolidine, trimethylamine or the like.

(2) When kansui is added, gluten contained in wheat shrinks to improve elasticity and smoothness (noodle making properties).

(3) Kansui acts on a flavonoid pigment contained in wheat to color resultant noodles in pale yellow.

As described above, when potassium lactate and kansui are used together, the noodle making properties of kansui are impaired and the elasticity of resultant noodles is deteriorated. Therefore, in the present invention, timing of adding potassium lactate and kansui is clearly divided, so as to make adjustment for exhibiting the functions of potassium lactate and kansui at a maximum.

1-3. Raw Material Powder

As the raw material powder, flour such as wheat flour, rice flour, rye flour, barley flour, adlay flour, Japanese millet flour, foxtail millet flour, corn flour, red bean flour, soy flour, buckwheat flour and quinoa flour, starch such as potato starch, tapioca starch and corn starch, and modified starch such as acetylated starch, etherified starch and crosslinked starch can be used.

In the present invention, the raw material powder preferably contains a protein. When the raw material powder contains a protein, the Maillard reaction occurs, and hence preferable well cooked feeling and appearance can be easily realized. When the raw material powder does not contain a protein, well cooked feeling and appearance can be imparted merely through caramelization, and hence, preferable well cooked feeling and appearance are difficult to realize.

Furthermore, in the present invention, the raw material powder preferably contains gluten, that is, a type of protein. When the raw material powder contains gluten, preferable well cooked feeling and appearance are realized, and in addition, noodle making properties are improved. Gluten of the present invention more specifically refers to a combination of glutenin and gliadin, or gluten. When glutenin, that is, a type of glutelin, and gliadin, that is, a type of prolamin, are reacted to bond with each other in the presence of moisture, gluten is obtained. Therefore, the combination of glutenin and gliadin is dealt with similarly to gluten.

The raw material powder used in the present invention is preferably wheat flour. Since wheat flour contains glutenin and gliadin, gluten can be obtained simply by kneading it with water added thereto to produce noodle dough. Wheat flour is classified into weak flour, all-purpose flour, strong flour, durum wheat flour and the like in accordance with a protein content, and any of these can be suitably used.

When a raw material powder not containing gluten, such as rice flour, barley flour or tapioca starch, is used instead of wheat flour, gluten is preferably added separately. Even when a raw material powder not containing gluten is used, noodle making properties and well cooked feeling similar to those obtained by using wheat flour can be realized by separately adding gluten.

The raw material powder is a principal component of instant noodles, and preferably occupies 50% by weight or more in the whole raw materials used in the present invention. When the content of the raw material powder is less than 50% by weight, noodle making properties are degraded and preferable well cooked feeling and appearance are difficult to obtain.

In the present invention, gluten is contained preferably in an amount of 2 to 30% by weight in the total amount of noodle strings. When gluten is contained in an amount of 2 to 30% by weight, balance between elasticity and extensibility of resultant noodles is good and texture of the noodles is good. Since the Maillard reaction appropriately occurs, the well cooked feeling and the appearance are good.

1-4. Sodium Chloride

It is said that excessive intake of sodium chloride increases a risk of hypertension, heart diseases and the like, but sodium chloride is the most common substance inducing a salty taste, and a bad taste becomes too strong when a substitute alone is used. In addition, sodium chloride acts on gluten to enhance the elasticity and extensibility of the noodle strings and to improve the noodle making properties and texture. Therefore, sodium chloride is preferably added in a certain amount also in the present invention.

In the present invention, sodium chloride is added preferably in an amount of 0.5 to 3 parts by weight with respect to 100 parts by weight of the raw material powder. When the amount of sodium chloride added is less than 0.5 parts by weight, the elasticity and the extensibility of the noodle strings are not adequately improved. On the other hand, when the amount of sodium chloride added exceeds 3 parts by weight, a salty taste owing to sodium chloride becomes sufficiently strong so that there is no need to compensate for a salty taste by adding potassium lactate.

1-5. Sub Materials

In the present invention, sub materials can be added in addition to the above-described raw materials. Specifically, xanthan gum used for adjusting texture of resultant noodles, a polysaccharide thickener such as pectin, a whole egg (for Chinese noodles) or spinach (for jade noodles) used for adjusting the hue of the noodles, a sugar such as glucose or fructose added for adjusting the hue and sweetness, a fragrance added for adjusting flavor, fat or oil for improving the noodle making properties, and the like can be used.

2. Production Method

Next, a production method for instant noodles will be specifically described.

(Step 1) Noodle Dough Production Step (Kneading Step)

Kneading water containing at least kansui is supplied to the raw material powder, and the resultant is kneaded to produce dough. The kneading time is not especially limited, and the kneading is performed generally for 5 to 30 minutes. The type of mixer to be used for the kneading is not especially limited either, and a batch mixer, a flow jet mixer and the like can be appropriately used. Furthermore, the kneading water may contain sub materials such as sodium chloride, a hue adjustor such as a reducing sugar, and a polysaccharide thickener.

(Step 2-1) Raw Noodle Strings Production Step

A production method for raw noodle strings can be a method (a) in which the dough obtained in Step 1 is compounded and rolled out to produce a noodle belt having a prescribed thickness, and the noodle belt is cut with a cutting blade or the like (cut noodles), a method (b) in which the dough is extruded through a hole with a prescribed size (extruded noodles), and a method (c) in which the dough is extended while being twisted to be formed into the shape of noodles (hand-rolled noodles). Examples of the cut noodles include Chinese noodles and udon, examples of the extruded noodles include spaghetti, and examples of the hand-rolled noodles include somen. These methods may be combined, and for example, a method in which a noodle belt produced by extrusion is cut (corresponding to a combination of the method (a) and the method (b)) can be employed.

(Step 2-2) Steaming and/or Boiling Step

In the present invention, the raw noodle strings may be steamed and/or boiled, if necessary, to obtain gelatinized noodle strings. Starch contained in wheat flour or the like is designated as raw starch, has a dense molecular structure, and is digested slowly, but when heated with water added thereto, the molecular structure is collapsed, and the starch becomes gelatinized starch, which is easily digested. The treatment temperature is not especially limited, and when the raw noodle strings are steamed with water vapor at normal pressure or boiled, the treatment temperature is 95 to 100° C., and when superheated water vapor is used, the treatment is performed generally at 100 to 350° C.

When a precedently gelatinized raw material powder (such as gelatinized wheat flour or gelatinized starch) is used, there is no need to perform the steaming and/or boiling step. Also when a method in which the noodle strings are boiled in hot water containing potassium lactate is employed in a flavoring step, there is no need to perform this step.

(Step 3) Flavoring Step

In the present invention, a step of adding potassium lactate to the noodle strings (hereinafter referred to as the “flavoring step”) needs to be provided. When potassium lactate is added after forming the noodle strings, a salty taste can be effectively imparted without impairing the noodle making properties of kansui by potassium lactate.

As a flavoring method, a method for dipping the noodle strings in a liquid seasoning (dipping method), and/or a method for spraying a liquid seasoning onto the noodle strings (spraying method) or the like can be appropriately employed.

The concentration of potassium lactate in the liquid seasoning used in the dipping method is preferably 1.0 to 10.0% by weight. When the concentration is lower than 1.0% by weight, the effect of increasing a salty taste is difficult to exhibit. Alternatively, when the concentration is 10.0% by weight or higher, the salty taste of the liquid seasoning is too strong, and hence the salty taste of the noodle strings is difficult to adjust.

In the present invention, from the viewpoint of improving a salty taste and texture, the step 2-2 is preferably provided for gelatinizing the noodle strings before the flavoring step.

The concentration of potassium lactate in the liquid seasoning is preferably 1.0 to 10.0% by weight. When the concentration is less than 1.0% by weight, the effect of increasing a salty taste is difficult to exhibit, and when the concentration is 10.0% by weight or higher, the salty taste of the liquid seasoning is too strong, and hence the salty taste of the noodle strings is difficult to adjust.

(Step 4) Cutting/Molding Step

In the production of cut noodles, the noodle strings are continuously conveyed on a conveyor up to the flavoring step in general, and in the cutting step, the noodle strings are cut to be provided as one meal amount. Then, the cut noodle strings are automatically put in a retainer (metal mold). In the production of extruded noodles or hand-rolled noodles, the noodle strings are generally sent to a drying step without performing the cutting/molding step.

(Step 5) Drying Step

Since the noodle strings contain 25 to 65% by weight of moisture before the drying step, it is necessary to dry the noodle strings to have 1 to 15% by weight of moisture for improving storability of resultant instant noodles. Representative drying methods are an instantaneous hot oil drying method and a hot-air drying method.

<Instantaneous Hot Oil Drying Method>

The instantaneous hot oil drying method is a method in which noodle strings are caused to pass through a hot oil at 100 to 200° C. for 1 to 4 minutes to dewater/dry the noodle strings to have about 1 to 5% by weight of moisture. The instantaneous hot oil drying method is not generally employed for extruded noodles and hand-rolled noodles not requiring molding.

<Hot-Air Drying Method>

The hot-air drying method is a method in which noodle strings are exposed to hot air at 50 to 170° C. for 10 to 180 minutes to dry the noodle strings to have about 8 to 15% by weight of moisture. In the hot-air drying method, there is no need to mold the noodle strings, and hence this method can be employed not only for cut noodles but also for extruded noodles and hand-rolled noodles.

### EXAMPLES

(Kneading Water)

Kneading water 1 was prepared by dissolving 3 parts of kansui (potassium carbonate: sodium carbonate=3:2) and 15 parts of sodium chloride in 345 parts of water. Kneading water 2 to 4 were also prepared by changing a mixing ratio of water, kansui, sodium chloride, potassium chloride and potassium lactate (78% aqueous solution) as shown in Table 1.

TABLE 1

Kneading Water

| | 1 | 2 | 3 | 4 |
|---|---|---|---|---|
| Kansui | 3.0 | 3.0 | 3.0 | 3.0 |
| Sodium Chloride | 15.0 | | | |
| Potassium Lactate | | 19.2 | | |
| (78% aqueous solution) | | | | |
| Potassium Chloride | | | 15.0 | |
| Water | 345.0 | 340.8 | 345.0 | 345.0 |

(Trial Examples)

900 parts of wheat flour and 100 parts of acetylated tapioca starch were powder mixed, 363 parts of the kneading water 1 was added thereto, and the resultant was mixed for 15 minutes using a batch mixer to produce crumbly dough 1 (Trial Example 1). Dough 2 to 4 (Trial Examples 2 to 4) were also produced by changing the kneading water 1 respectively to the kneading water 2 to 4.

(Evaluation of Dough Properties)

Each of the doughs 1 to 4 was evaluated for dough properties using a Farinograph (manufacture by Brabender). A Farinograph refers to an apparatus for measuring, as hard viscosity (FU: Farinograph unit), a torque applied to an axis of rotation in the process for mixing the noodle dough, and specific measurement conditions in the present invention are as described below. Although a mixing time for the dough 1 to 4 was 15 minutes as described above, the mixing was performed for 60 minutes in the evaluation of the dough properties.

Measurement Apparatus: Farinograph E (manufactured by Brabender)

Amount of Powder: 200 g

Amount of Water added: 70 g

Temperature: 30° C.

Speed of Mixing Blade: 45 l/min

Measurement Time (Mixing Time): 3600 seconds

Measurement Interval: 2 seconds

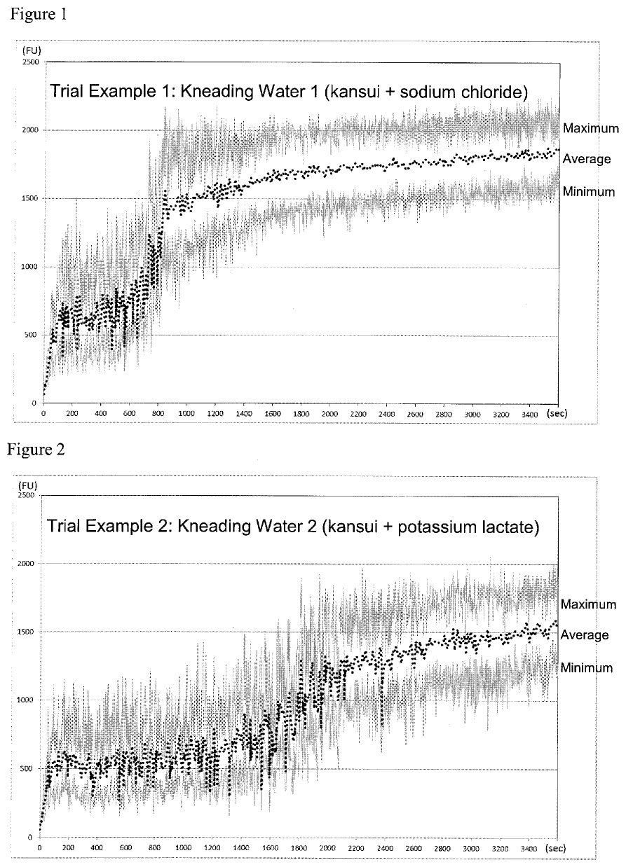

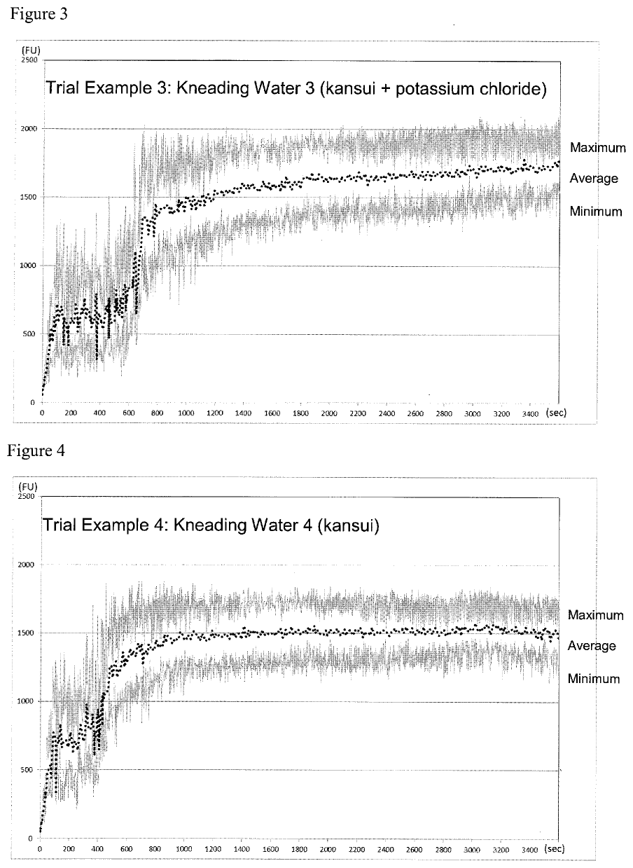

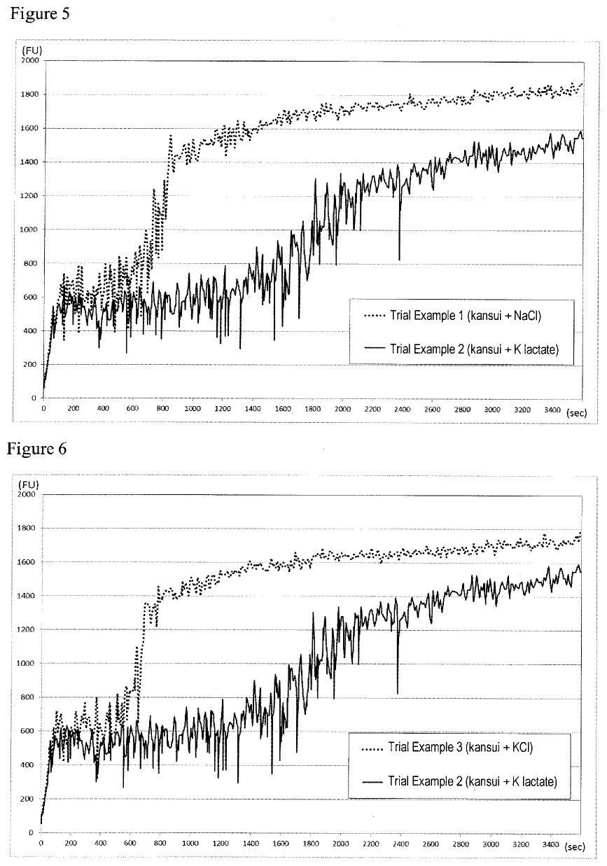

The outline of the evaluation of the dough properties is shown in Table 2. Although there is a prescribed range of variation in the hard viscosity obtained using the Farinograph, the hard viscosity shown in Table 2 is an average of such varied values. The measurement results (a minimum value, an average value and a maximum value) of each trial example are illustrated in FIGS. 1 to 4, and comparison of Trial Example 2 (using potassium lactate in the kneading water) with the other trial examples are illustrated in FIGS. 5 to 7.

TABLE 2

| | | Trial | Trial | Trial | Trial |
|---|---|---|---|---|---|
| | | Example 1 | Example 2 | Example 3 | Example 4 |
| | | Dough 1 | Dough 2 | Dough 3 | Dough 4 |
| Kneading | | Kneading | Kneading | Kneading | Kneading |
| Water | | Water 1 | Water 2 | Water 3 | Water 4 |
| | | Kansui | Kansui | Kansui | Kansui |
| | | Sodium | Potassium | Potassium | |
| | | Chloride | Lactate | Chloride | |
| | pH | 10.4 | 10.7 | 10.8 | 11.0 |
| Hard Viscosity | after 15 min | 1420 | 640 | 1380 | 1460 |
| (FU) | (900 sec) | | | | |
| | at end (after | 1870 | 1550 | 1790 | 1470 |
| | 3600 sec) | | | | |
| | Maximum Hard | 1880 | 1590 | 1790 | 1580 |
| | Viscosity | | | | |

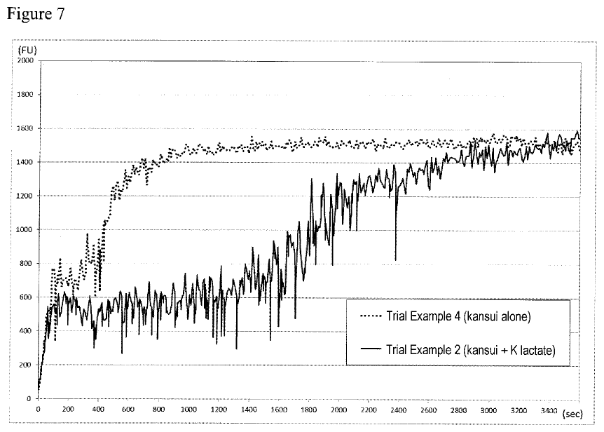

It is understood, as is obvious from Table 2 and FIG. 7, that formation of the dough is delayed when potassium lactate is added, and thus, the noodle making properties are impaired. In addition, as is obvious from Table 2 and FIGS. 6 and 7, potassium lactate cannot be expected to present an effect of increasing the maximum hard viscosity (elasticity of noodles) differently from sodium chloride or potassium chloride. Accordingly, it is necessary to add potassium lactate not during noodle making but after the noodle making.

### Example 1

The dough 1 was compounded and rolled out by a shaping roll into a noodle belt with a thickness of 0.9 mm, the noodle belt was cut with a cutting blade roll (round blade No. 20, groove width: 1.5 mm) to obtain noodle strings, and the noodle strings were steamed with saturated steam of 270 kg/h for 2 minutes.

The thus steamed noodle strings were dipped for 20 seconds in a liquid seasoning 1 containing 70 parts of sodium chloride, 25.6 parts of potassium lactate (78% aqueous solution) and 994.4 parts of water, and the resultant was cut into a length of about 30 cm (100 g) and filled in a retainer. The noodle strings in the retainer were dried in palm oil at 150° C. for 2 minutes and 30 seconds (the instantaneous hot oil drying method) to produce instant noodles 1 having a moisture content of 2% by weight. The weight of the noodle strings filled in the retainer was 100 g, and the weight of the instant noodles after drying was 66 g.

### Comparative Example 1

The dough 2 was compounded and rolled out by a shaping roll into a noodle belt with a thickness of 0.9 mm, the noodle belt was cut with a cutting blade roll (round blade No. 20, groove width: 1.5 mm) to obtain noodle strings, and the noodle strings were steamed with saturated steam of 270 kg/h for 2 minutes.

The thus steamed noodle strings were dipped for 20 seconds in a liquid seasoning 2 containing 90 parts of sodium chloride and 1000 parts of water, and the resultant was cut into a length of about 30 cm (100 g) and filled in a retainer. The noodle strings in the retainer were dried in palm oil at 150° C. for 2 minutes and 30 seconds (the instantaneous hot oil drying method) to produce instant noodles 2 having a moisture content of 2% by weight. In the same manner as in the production of the instant noodles 1, the weight of the noodle strings filled in the retainer was 100 g, and the weight of the instant noodles after drying was 66 g.

### Comparative Example 2

The dough 4 was compounded and rolled out by a shaping roll into a noodle belt with a thickness of 0.9 mm, the noodle belt was cut with a cutting blade roll (round blade No. 20, groove width: 1.5 mm) to obtain noodle strings, and the noodle strings were steamed with saturated steam of 270 kg/h for 2 minutes.

The thus steamed noodle strings were dipped for 20 seconds in the liquid seasoning 2 containing 90 parts of sodium chloride and 1000 parts of water, and the resultant was cut into a length of about 30 cm (100 g) and filled in a retainer. The noodle strings in the retainer were dried in palm oil at 150° C. for 2 minutes and 30 seconds (the instantaneous hot oil drying method) to produce instant noodles 3 having a moisture content of 2% by weight. In the same manner as in the production of the instant noodles 1, the weight of the noodle strings filled in the retainer was 100 g, and the weight of the instant noodles after drying was 66 g.

(Salty Taste)

The salty taste was evaluated by ten expert panelists with that of Comparative Example 2 used as a reference as follows.

good: Nine or more panelists evaluated that the salty taste was equivalent to or stronger than that of Comparative Example 2.

bad: The other evaluation results.

TABLE 3

| | | | | Comparative | Comparative |
|---|---|---|---|---|---|
| | | | Example 1 | Example 1 | Example 2 |
| | | | Instant | Instant | Instant |
| | | | Noodles 1 | Noodles 2 | Noodles 3 |
| Dough (parts) | | | Dough 1 | Dough 2 | Dough 1 |
| | | Wheat Flour | 900 | 900 | 900 |
| | | Acetylated Tapioca | 100 | 100 | 100 |
| | | Starch | | | |
| | Kneading Water | Kansui | 3 | 3 | 3 |
| | | Sodium Chloride | 15 | | 15 |
| | | Potassium Lactate | | 19.2 | |
| | | (78% aqueous | | | |
| | | solution) | | | |
| | | Water | 345 | 340.8 | 345 |
| | | Total | 1363 | 1363 | 1363 |

| | | | | |
|---|---|---|---|---|
| Liquid Seasoning | Sodium Chloride | 70 | 90 | 90 |
| (parts) | Potassium Lactate | 25.6 | | |
| | (78% aqueous | | | |
| | solution) | | | |
| | Water | 994.4 | 1000 | 1000 |
| | Total | 1090 | 1090 | 1090 |

| | | | |
|---|---|---|---|
| Salty Taste | ∘ | ∘ | ∘ |
| | | | control |
| Dough Properties | ∘ | x | ∘ |

### CONCLUSION

It is obvious, from the evaluation of the dough properties, that potassium lactate impairs the noodle making properties. On the other hand, there is substantially no difference in the salty taste no matter whether potassium lactate is added to kneading water or to the liquid seasoning used after noodle making. Accordingly, when potassium lactate is added not during the noodle making but after the noodle making, a salty taste can be efficiently imparted with texture of noodles retained.

1. A method for producing instant noodles, comprising at least the following steps 1 to 3:
step 1 of kneading a raw material powder, water and kansui to produce noodle dough;
step 2 of producing noodle strings from the noodle dough; and
step 3 of adding potassium lactate to the noodle strings.

2. The method for producing instant noodles according to claim 1, wherein the raw material powder contains gluten.

3. The method for producing instant noodles according to claim 1, wherein the noodle strings are gelatinized before the step 3.

4. The method for producing instant noodles according to claim 1, wherein the raw material powder contains wheat flour.
